(19) United States
(12) Patent Application Publication
(10) Pub. No.: US 2004/0103036 A1
(43) Pub. Date: May 27, 2004

(54) Method and system for communication checking

(76) Inventors: Bjorn Nilsson, Jarlasa (SE); Par Rosander, Uppsala (SE); Lars Andersson, Uppsala (SE)

Correspondence Address: YOUNG & THOMPSON, 745 SOUTH 23RD STREET 2ND FLOOR, ARLINGTON, VA, 22202

(21) Appl. No.: 10/311,864

(22) PCT Filed: Jun. 18, 2001
(86) PCT No.: PCT/SE01/01381

(30) Foreign Application Priority Data
Jun. 20, 2000 (SE) 0002302-8

(51) Int. Cl. G06F 17/60

(52) U.S. Cl. 705/20

(57) ABSTRACT

The present invention relates to systems, devices and methods for communicating between a central control unit (16) and/or a hand-held communication device (17), and at least one electronic shelf label (1). The invention provides systems, devices and methods for detecting if authorised or unauthorised communication with said at least one electronic shelf label (1) has occurred. The invention also provides for space management compliance.

### TECHNICAL FIELD OF THE INVENTION

The present invention relates to a method and a device for detecting authorised and unauthorised communication with electronic shelf labels.

### DESCRIPTION OF RELATED ART

In many shops, price information for the goods on display is shown on labels located on the edges of the shelves supporting the goods. Recently automatic price information systems have become available. WO-A-90/14630 discloses a price information system comprising electronic shelf labels (ESLs). These labels, which are mounted on shelves in shops, are in the form of individual price display units comprising a display screen, an internal power source, memory for storing price information and other information such as the weight or size of the associated product, and a receiver for remote communication with a master control unit. This master control unit broadcasts price information which can be specifically addressed to an individual electronic shelf label which, after receiving the transmitted information, displays the price information on its display screen. The advantage of such systems is that the consuming and error-prone manual changing of labels is avoided. However, some work still needs to be performed by hand in the shops, for example checking the amount of stock on the shelves and filling the shelves. It is important that the number of units of stock of a product on a shelf never falls to zero as this gives rise to an empty space on the shelf and can lead to customers having a bad image of the shop. It is not however possible to rule out human error which can allow some products to missed out when the checking is taking place—which leads to empty shelves. Furthermore, it is possible that unauthorised persons tamper with the electronic shelf labels and input incorrect price information into labels. This can lead to customer bad-will if the displayed price which the customer sees when selecting his or her purchases is lower than the checkout price which the customer is then asked to pay. Space management compliance is another problem in retail stores and similar today. In many stores the supplier of the goods puts the goods directly onto the shelf. There is a risk that the supplier will try to get his product to occupy a larger space on the shelf. The available space management software does not make any sense if not the optimized planning of the shelf is achieved in the store.

### SUMMARY OF THE INVENTION

The object of the invention is to solve the above stated problems.

The present invention solves the above stated problems by means of systems having the features mentioned in the characterising part of claim 1. The above problems are also solved by means of devices having the features mentioned in the characterising part of claim 5. The above problems are also solved by means of a method having the features mentioned in the characterising part of claim 7.

In a system, method and device in accordance with a first embodiment of the present invention, unauthorised communication can be detected by checking the contents of a memory means such as a check sum register in a labels after setting all the check sums in the labels to the same code.

In a second embodiment of the invention, unauthorised communication can be detected by comparing the expected contents of a memory means such as a check sum register in a label against the actual contents of the register in the label.

In a further embodiment of the invention, an electronic shelf label is provided with memory means for storing the identity of the last device that communicated with it. These memory means can be interrogated by a controlling or checking device in order to check the identity of the last person communicating with the ESL.

This makes it possible to identify unauthorised communication with an ESL.

The invention will be described more closely in the following by means of non-limiting examples of embodiments and a FIGURE illustrating one possible embodiment of the present invention.

### BRIEF DESCRIPTION OF THE DRAWING

FIG. 1 is a schematic view of the main components of one embodiment of an electronic shelf label in accordance with the invention.

### DETAILED DESCRIPTION OF EMBODIMENTS

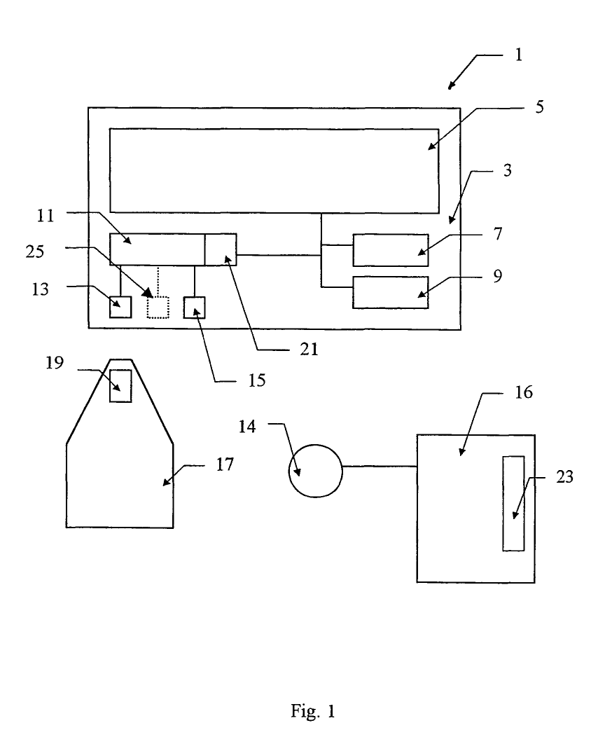

FIG. 1 shows schematically one embodiment of an electronic shelf label (ESL) 1. For the sake of brevity, only those parts of the ESL 1 that are of relevance to the present invention are shown in FIG. 1. The ESL 1 has a casing 3 that has a display means 5 such as a liquid crystal display (LCD) which can display information. The casing is intended to be attached to a shelf, basket, pallet, bin or the like in a shop and can display price information stored in a first data memory or register 7 on display means 5. The display 5 can also be made to display other information, such as how much shelf space the product has been allocated. This other information can be stored in another memory such as second data memory or register 9. The display 5 is controlled by control means 11 such as an integrated circuit, microprocessor or the like, which normally controls display 5 to show the price information contained in first data register 7. Control means 11 is connected to communication means which comprise at least a receiver means 13 for receiving information and which may also comprise transmitting means 15 for transmitting information. Receiver means 13 can be a wireless sensor such as an infra-red (IR) sensor and it can receive information or instructions transmitted from a suitable short range, hand-held wireless communication means 17, such as an infra-red key (IR key) which is intended to communicate with only one ESL at a time by means of an IR transmitter means such as IR light emitting diode (LED) 19. Receiver means 13 is also intended to receive information or instructions transmitted, preferably wirelessly, by a global transmitter 14 controlled by a central control unit such as a computer 16. The global transmitter can broadcast signals 14 that can be received by a plurality of ESLs simultaneously.

IR key 17 is intended to be used by an authorised operator such a member of the shop's staff when engaged in stock checking or shelf filling activities. The operator can place the transmitter means 19 of the IR key 17 in the vicinity of the ESL receiver means 13 in order to send instructions or information to the control means 11 of the ESL 1. When filling shelves the operator can send an instruction “SHOW 2” from the IR key 17 to the control means 11 which causes the control means 11 to make the display means 5 display the contents of the second data register 9 on the display for a pre-set period of time, for example, 30 seconds. Thus, using the example above concerning the contents of the second data register 9, for this pre-set period of time the display 5 will display how much shelf space the product has been allocated, e.g. “6” or “6 units” which would instruct the operator that the row of the product should be 6 units (e.g. bottles, cans or packets) wide. At the end of this period of time the display will revert to displaying the information in the first data register 7. The space management software systems employed for the purpose of optimizing the utilization of shelf space, feeds the system according to the invention with appropriate data.

A data transmission protocol is usually used whenever information is transmitted between an ESL 1 and a central control unit 16 or IR key 17. Such a protocol typically gives details of how much information is to be transmitted and the order in which information is to be transmitted. For example, a message can be broken down into a number of data packages containing the address to which the message is intended to be sent, some information (e.g. a price) and a check sum. The check sum (also known as a cyclic redundancy check, CRC) has a value that is based on the content of the message and is calculated from an algorithm or formula by the originating unit, e.g. the central control unit 16 or IR key 17, for the message and tagged onto the end of the message. The receiving ESL 1 calculates a check sum based on the content of the message using the same algorithm or formula, and if it has the same value as the check sum transmitted with the message then it means that the received message corresponds exactly with the transmitted message. If this is the case then the receiving ESL 1 can acknowledge correct receipt of the message by simply sending a “YES” acknowledgement signal which can consist of the address of the receiving ESL 1 or a simple message which means “yes”. In the simplest model of an ESL if the check sums are different or the response to a command is “NO” then the receiving ESL 1 does not transmit a reply. Thus in the simplest ESL the only reply that a receiving ESL 1 can make is a reply equivalent to a “YES” or no reply at all. If the originating unit 16 or 17 does not receive a reply from a ESL 1 then this means that either the original message was not (correctly) received or the message was correctly received but the “YES” reply from the receiving ESL 1 was blocked or that the command was so-formulated that the correct response from the receiving ESL 1 was not “YES”—in which case the receiving ESL 1 correctly does not send a reply. In order to avoid any ambiguity commands are preferably always phrased so that the expected response should be a “YES”. In the event of no reply coming from the receiving ESL 1 the originating unit 16 or 17 can take the appropriate action, for example, re-transmit the original message or transmit a rephrased message so that the new expected response is “YES”. Every time (except for the exceptions mentioned below) a ESL 1 transmits a message or performs an action based on a correctly received instruction then it calculates a check sum and stores the latest check sum in a CRC register, e.g. CRC register 21 in the ESL 1.

There are a few instructions that do not cause the calculation of a new CRC. One such instruction is the instruction “LAST CRC” which causes the ESL 1 which receives this instruction to transmit a “YES” if the last CRC stored in its register is the same as the expected CRC contained in the data field in the instruction message (the expression “expected CRC” means the CRC which was calculated for the previous message from the central control unit 16 to the receiving ESL 1 and which the control unit expects the receiving device to still have in its register). Another such instruction is “NOT LAST CRC” which causes the ESL 1 that receives this instruction to transmit a “YES” if the last CRC stored in its register is not the same as the expected CRC in the data field in the instruction message.

If the ESL 1 is commanded by an infra red key 17 to show the contents of the second data register 9 on the display 5 then it will calculate and store in register 21 a check sum which has a value X which corresponds to the instruction “SHOW 2”.

In accordance with the present invention the information stored in the CRC register 21 can be used in several different methods to check if manual stock replenishing and stock checking have taken placed as planned and to check that no unauthorised changes have been made to any ESLs. Descriptions of preferred embodiments of the present invention that use such methods follow.

In a first embodiment of the invention when a check is to be made on the system the central control unit 16 causes a global message such as “PING” to be transmitted. This causes all ESLs to reply with a “YES” and they also change their CRC registers 21 so that they contain the individual check sum corresponding to this message. The expected check sum that each ESL should have is also calculated by the central control unit 16 and stored in a security register 23 in the central control unit. The correct receipt of the “PING” instruction can be confirmed by the central control unit 16 sending an order “LAST CRC” to each ESL. This order contains the expected CRC for each ESL and requests each ESL to transmit a “YES” message if the contents of its CRC register 21 corresponds to the expected CRC retrieved from the security register 23 in the central control unit 16 and sent with the “LAST CRC” order. Each ESL should then transmit a “YES” if its check sum corresponding to the “PING” instruction which was received before the “LAST CRC” order was sent (as mentioned above, the instruction “LAST CRC” does not cause a new check sum to be calculated) is the same as the expected check sum stored in the security register 23 of central control unit 16 for that particular ESL. If no “YES” is received from an ESL then this indicates that an error has occurred and appropriate action can be taken such as re-sending the “LAST CRC” message. If still no response is received then a “NOT LAST CRC” message can be transmitted. This should cause the receiving ESL 1 to reply with a “YES” if the communication between the ESL and the central control unit is functioning normally. If still no response is received from this message then it can be assumed that the communication between the ESL and the central control unit is not functioning.

Checking of the products on the shelves can then commence. Each ESL should then be interrogated by an operator who uses his IR key to send the message “SHOW 2” to the label in order to find out e.g. how many rows of product should be on the shelf. This causes the check sum in the CRC register 21 of each checked ESL to correspond to the instruction “SHOW 2” instead of “PING”. To check how the manual checking of the shelves is progressing the central control unit can send out a last CRC checking message which orders all ESLs which do not have a check sum in register 21 corresponding to “SHOW 2” to respond. Thus all ESLs which have not been checked will reply, while the ESLs which have been checked will not reply and will not change the check sum, i.e. they will retain the check sum corresponding to “SHOW 2”. If no other instructions are sent to the ESLs then as the manual checking progresses fewer and fewer ESLs will reply to the checking message. The manual checking can be considered complete when no replies are received in response to the checking message.

If an ESL has been tampered with, i.e. subjected to unauthorised communication, during the manual checking then it will either be detected during the manual checking by the checking person or, if the tampering occurred after a label had been checked manually then the label will no longer have “SHOW 2” in its CRC register. If an ESL which previously did not respond to a checking message suddenly begins to respond to such a message then it is a sign that the ESL has been tampered with and appropriate action, such as manually inspecting the ESL 1, can then be taken.

In another embodiment of the invention, the last transmitted contents of each CRC register 21 can be stored in a security register 23 in central control unit 16. The ESL can be provided with more advance communication possibilities so that it can transmit replies other than just a “YES” message, for example, a copy of a received transmission or a number corresponding to the contents of a register etc. At the beginning of a checking procedure, the central control unit can transmit a checking message “LAST CRC” which instructs each ESL to reply with a message that contains the contents of its CRC register 21. This causes all the ESLs to reply with such a message. No new check sum is calculated (as mentioned above the instruction “LAST CRC” does not cause a new check sum to be calculated). The security register 23 then contains an entry for each ESL in which the check sum corresponds to the next-to-last message sent to the ESL and which is the actual check sum in the CRC register 21 of each ESL 1. Each time a specific instruction is sent by the central control unit to a specific ESL the entry in security register 23 is updated to correspond to the specific instruction. Whenever it is necessary to check the security of the system, the central control unit transmits the checking message “LAST CRC” to each ESL. Each ESL then transmits the contents of its CRC register 21. The central control unit receives these messages and uses comparison means (not shown) to compare the message from each ESL against the entry for that ESL in security register 23. These entries contain the expected CRC i.e. the CRC that is expected to be received from each ESL. If the expected CRC entry is the same as the contents of the CRC register transmitted in the message then no unauthorised communication with an ESL has taken place. If the transmitted CRC is “SHOW 2” then normal manual checking activity has taken place. If the transmitted CRC for an ESL is not the same as the expected CRC in the security register 23 and is not “SHOW 2” then the central control unit determines that this ESL has been tampered with e.g. it has been the subject of unauthorised communication and appropriate action must be taken.

In another embodiment of the present invention, each ESL is provided with a register for storing information on the identity of the last IR key or the like, which communicated with the ESL. This naturally requires that each IR key or the like is provided with some identifying means such as a unique identifying code, which can be transmitted to the ESL. This code could be stored in a register in the ESL. The register could be a separate identity-storing register that is only used to store the identity of the last IR key that communicated with the ESL. Alternatively, this information could be stored in an existing register, for example, a security register. The ESL could also be provided with memory means, such as a register or registers, for storing information on the last command or commands sent to the ESL, so that it is possible to see who sent what instructions to the ESL. The ESL can additionally be provided with storage means, such as one or more communication logging registers 25, for storing information on the dates and/or times that the ESL was communicated with. The communication logging register(s) is/are preferably able to be read by the central control unit and/or a handheld transmitter. The information in a communication logging register can be, for example, transmitted on demand to the central control unit or it could be automatically transmitted at predetermined times. This facility can be used, for example, to check who last accessed an ESL and when. This is useful for store management who usually need some way of checking that the employees are actually visiting the store shelves and refilling them on a timely basis. By requiring the employees to communicate with the ESL by means of the IR key or the like every time they refill a shelf, it is possible to check when and by whom a shelf was last refilled. The information stored in the communication logging register can be limited to information concerning just the last communication in order to minimise the size of the register. Alternatively, the communication logging register can be enlarged so that it can contain information about a plurality of communications. This information, in the form of a list of, for example, the last ten devices (e.g. IR keys or central controllers) which communicated with the ESL and when they communicated with it, can be downloaded to the central control system and/or mobile equipment such as IR keys, when required, for example, once a day in order to check that the shelves have been checked and in order to detect any unauthorised communications, i.e. communications from an unknown IR key or an unauthorised employee's IR key.

The invention is naturally not limited to devices having just two data registers but can be used with devices having more or fewer data registers. It is furthermore applicable to any wireless communication system, e.g. using radio.

The present invention is not limited to the above-described embodiments but covers all variations and modifications that fall under the scope of the following claims.

1. Electronic shelf label system, comprising at least one electronic shelf label (1) and a central control unit (16), characterised in that the system optionally comprises a hand-held communication device (17) for communication with only one electronic shelf label at a time, the system comprising means for detecting if authorised or unauthorized communication between said at least one electronic shelf label (1) and the hand-held device or some other communication device has occurred, using the central control unit (16) for said detection.

2. The system as claimed in claim 1, wherein the label has a means for storing the identity of the last device that communicated with the label.

3. System in accordance with claim 1 or 2, further comprising a memory means (21) for storing a check sum, and means for transmitting a signal corresponding to the contents of said register (21) as a response to a signal from said central control unit or said hand-held communication device (17), and wherein said central control unit or said hand-held containing the last check sum for said electronic shelf label (1), and wherein said central control unit (16) comprises means for sending a request to ESL to compare said ESL memory means with said last check sum stored in said security register and, and means for determining that communication between ESL and another device than the central unit has taken place if the comparison shows that the check sum stored in the ESL and the last check sum stored in the security register (23) are different.

4. System in accordance with claim 1, characterised in that said at
least one electronic shelf label (1) has means for transmitting an acknowledgement signal as a response to a signal from said central control unit (16) or said hand-held communication device (17).

5. System in accordance with any of the previous claims,
characterised in that said central control unit (16) comprises security register means (23).

6. System in accordance with any of the previous claims,
characterised in that said memory means is a check sum register (21) and/or a security register.

7. Method for detecting authorised and unauthorised communication with electronic shelf labels (1) in an electronic shelf label system as claimed in claim 1, characterised in that it comprises the steps of:
providing each electronic shelf label with a memory means (21), and means for transmitting an acknowledgement signal as a response to a signal from a central control unit (17) in said system;
providing said central control unit with security register means (23) for storing an expected check sum which corresponds to the expected check sum which it is expected that each untampered-with electronic shelf label would have in its memory;
for each label, calculating a check sum corresponding to the last instruction received by said label from said central unit or said hand-held device and storing the check-sum in said memory (21);
interrogating a selected shelf label whether it has an expected check sum or not.

8. The method as claimed in claim 7, comprising the step of:
if the ESL has been tampered with in an unauthorized manner with an authorized hand-held device, presenting what type of HHD it was.

9. Method in accordance with claim 8, characterised by the further step of:
providing the electronic shelf label (1) with storage means, such as one or more communication logging registers, for storing readable information on the dates and/or times that the electronic shelf label was communicated with.

10. Method in accordance with claim 8 or 9, characterised by the further step of: providing the electronic shelf label (1) with storage means, such as one or more communication logging registers (25), for storing readable information on the identity of any devices that previously has/have communicated with the electronic shelf label.

11. Method in accordance with any of claims 6-10, wherein said memory means (21) is a check sum register (21) and/or a security register.
